(19) United States
(12) Patent Application Publication
(10) Pub. No.: US 2026/0037440 A1
(43) Pub. Date: Feb. 5, 2026

(54) TAG IDENTIFIER FOR A MEMORY DEVICE

(71) Applicant: Micron Technology, Inc., Boise, ID (US)

(72) Inventor: David Y. Kao, Frisco, TX (US)

(21) Appl. No.: 18/788,929

(22) Filed: Jul. 30, 2024

(51) Int. Cl. G06F 12/02; G06F 12/0895; G06F 12/14

(52) U.S. Cl. CPC G06F 12/0292; G06F 12/0895; G06F 12/1491

(57) ABSTRACT

Systems, methods, and apparatuses are provided for a tag identifier for a memory device. A dynamic random access memory (DRAM) array can be coupled to a controller that is configured to maintain a tag match table indicating correspondence between a respective tag identifier and a respective plurality of DRAM addresses for each of a plurality of tag identifiers, receive a memory access request that includes a particular tag identifier, retrieve the respective plurality of DRAM addresses corresponding to the particular tag identifier from the tag match table, and access memory corresponding to the respective plurality of DRAM addresses.

### TECHNICAL FIELD

The present disclosure relates generally to memory devices, and more particularly, to apparatuses and methods related to a tag identifier for a memory device.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM) such as dynamic random access memory (DRAM), an example of which is synchronous dynamic random access memory (SDRAM), among others. Static Random-Access Memory (SRAM) is another kind of volatile random access memory. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, Solid-State Drive (SSD), and other electronic devices.

### BRIEF DESCRIPTION OF THE DRAWINGS

FIG. 1 is a block diagram of an apparatus in the form of a memory device according to the present disclosure.

FIG. 2 is a table for a tag match engine of a memory device according to the present disclosure.

FIG. 3 illustrates a plurality of memory banks including DRAM addresses and a tag identifier according to the present disclosure.

FIG. 4 illustrates a method for retrieving data that has been tagged with a tag identifier according to the present disclosure.

FIG. 5 illustrates an example machine of a computer system within which a set of instructions, for causing the machine to perform any one or more of the methodologies discussed herein, can be executed.

### DETAILED DESCRIPTION

The present disclosure includes apparatuses and methods related to a tag identifier for a memory device. A memory device can include a dynamic random access memory (DRAM) array and a controller coupled to the DRAM array. The controller can be configured to maintain a tag match table indicating correspondence between a respective tag identifier and a respective plurality of DRAM addresses for each of a plurality of tag identifiers, receive a memory access request that includes a particular tag identifier, retrieve the respective plurality of DRAM addresses corresponding to the particular tag identifier from the tag match table, and access memory corresponding to the respective plurality of DRAM addresses.

Typical DRAM access operations can include read operations and write operations. The data involved in read operations and write operations is stored in locations in a memory array that correspond to addresses in the memory array. When a large amount of data is involved in an access operation, the access operation should be scheduled around a refresh schedule of the die, bank, row, and/or memory cells storing the data. This can decrease the efficiency of a memory device because, due to the access operations needing to accommodate the refresh schedule, there can be periods of time in which memory operations cannot be executed on certain portions of memory. A physical portion of memory is referred to herein as a memory location. If an access operation is attempted on a memory location that is experiencing a refresh, the access operation might not access the memory location and a subsequent request may be sent to access the memory location after the refresh operation is complete.

Further, with typical DRAM access operations, multiple requests for data are used to access disparate memory array addresses (e.g., in different memory banks). This can decrease the speed at which a memory device operates because an input/output (I/O) line may not be able to efficiently transfer that amount of data.

In previous approaches, more I/O lines would be built into a memory system to decrease the load on each individual I/O line. This can increase the cost of manufacturing a memory system since more I/O lines are being fabricated. Further, in previous approaches, memory systems would send a subsequent request for data if a previous request for data was unsuccessful due to the requested data being stored in a DRAM address that was experiencing memory operation while a controller attempted to complete the request for data.

In order to address these and other issues associated with some previous approaches, at least one embodiment of the present disclosure includes a tag identifier (e.g., a data tag) that associates (e.g., links) a first memory location with a second memory location. A relatively large amount of data can then be stored in the first memory location and the second memory location using a single tag identifier instead of multiple addresses. Likewise, the relatively large amount of data can be read from the first memory location and the second memory location using the tag identifier instead of multiple addresses. Using a tag identifier to associate data stored in a first memory location with data stored in a second memory location allows both the data stored in the first memory location and data stored in the second memory location to be retrieved when the memory device receives a request for the data stored in the first memory location. This can decrease the amount of data (address information, command information, etc.) being transferred through the I/O line since one request can retrieve data stored in multiple memory locations instead of needing multiple requests to retrieve data stored in multiple memory locations.

Further, embodiments of the present disclosure allow a memory device to accommodate a refresh schedule in a more efficient manner than previous approaches. For example, when a second memory location is linked to a first memory location through a tag identifier, a request for the data stored in the first memory location can be being executed while the second memory location is experiencing a refresh. Then, once the refresh operation is complete, the memory controller can retrieve the data stored in the second memory location without any additional commands or addresses being received (e.g., from a host).

As used herein, the singular forms “a,” “an,” and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

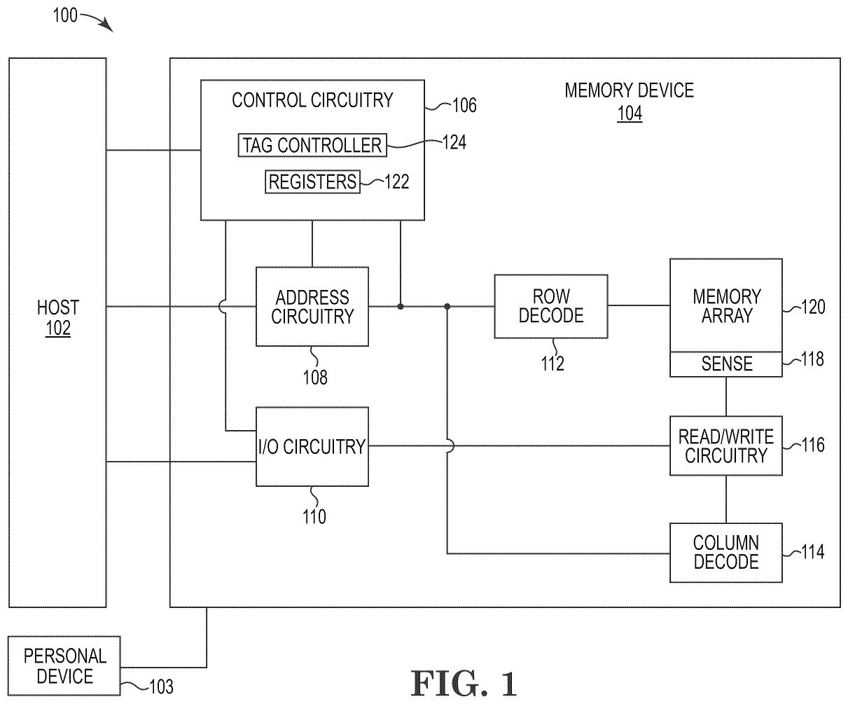

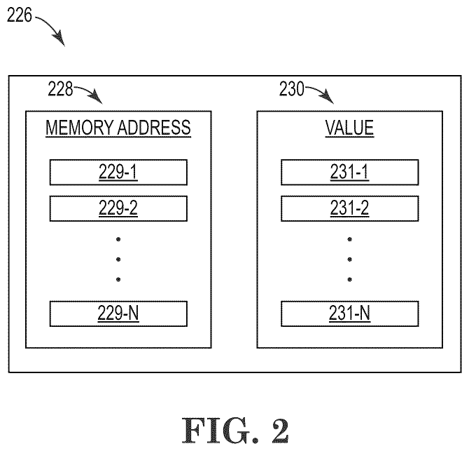

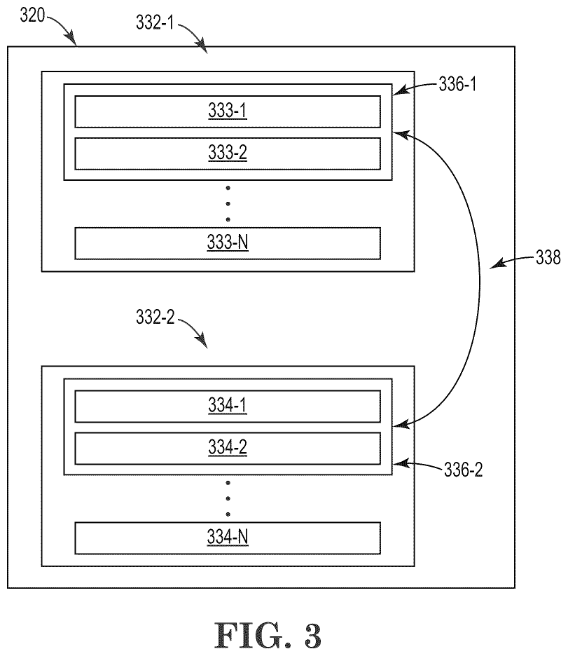

The figures herein follow a numbering convention in which the first digit or digits correspond to the drawing figure number and the remaining digits identify an element or component in the drawing. Similar elements or components between different figures may be identified by the use of similar digits. For example, 120 may reference element “20” in FIG. 1, and a similar element may be referenced as 320 in FIG. 3. Analogous elements within a Figure may be referenced with a hyphen and extra numeral or letter. Such analogous elements may be generally referenced without the hyphen and extra numeral or letter. For example, elements 229-1, 229-2, . . . , 229-N in FIG. 2 may be collectively referenced as 229. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of an apparatus in the form of a memory device 104 according to the present disclosure. A system 100 can comprise the memory device 104 coupled to a host 102 via an interface, and a personal device 103 coupled to the memory device 104 via an interface. As used herein, a host 102, a memory device 104, or a memory array 120, for example, might also be separately considered to be an “apparatus.” As used herein, a “personal device” refers to a device external to the host 102 and the memory device 104 through which a user can access the data in the memory device 104. As will be described later in more detail, the personal device 103 can access data stored in one or more DRAM addresses of the memory device 104. The interface can pass control, address, data, and other signals between the memory device 104 and the host 102. The interface can include a command bus (e.g., coupled to the control circuitry 106), an address bus (e.g., coupled to the address circuitry 108), and a data bus (e.g., coupled to the input/output (I/O) circuitry 110). In some embodiments, the command bus and the address bus can be comprised of a common command/address bus. In some embodiments, the command bus, the address bus, and the data bus can be part of a common bus. The command bus can pass signals between the host 102 and the control circuitry 106 such as clock signals for timing, reset signals, chip selects, parity information, alerts, etc. The address bus can pass signals between the host 102 and the address circuitry 108 such as logical addresses of memory banks in the memory array 120 for memory operations. The interface can be a physical interface employing a suitable protocol. Such a protocol may be custom or proprietary, or the interface may employ a standardized protocol, such as Peripheral Component Interconnect Express (PCIe), Gen-Z interconnect, cache coherent interconnect for accelerators (CCIX), etc. In some cases, the control circuitry 106 is a register clock driver (RCD), such as RCD employed on an RDIMM or LRDIMM.

Logical addresses may also be referred to in the art as host addresses and are distinguished from physical addresses of the memory array 120. From the perspective of the host 102, a logical volume of the memory array 120 is available for user data and that logical volume can be indexed by a series of logical addresses at an arbitrary granularity. The logical addresses allow the host 102 to regard the logical volume as a contiguous block of memory, regardless of where the data is actually physically stored. The memory device 104, on the other hand, uses physical addresses of the memory array 120 to read and write data where it is actually stored in the physical volume of memory. The memory device 104 can include logical to physical address translation circuitry to map between logical and physical addresses. In some embodiments, the host 102 may be responsible for performing translation between logical and physical addresses (e.g., where the logical addresses are used by applications running on the host 102 and the host 102 addresses the memory device 104 using physical addresses of the memory device 104). Regardless of whether the host 102 or memory device 104 is responsible for logical and physical address translation, logical addresses are distinguished from tag identifiers as described herein. Whatever granularity a given system 100 uses for logical addresses, tag identifiers have a higher level of granularity (e.g., one logical address describes a lesser amount of data than one tag identifier). Furthermore, a tag identifier describes a unique data set as a collective, where the data set is stored at more than one logical (and physical) address. In contrast, logical addresses may be agnostic to the data stored therein (e.g., whether that data is part of less than one full data set or more than one full data set is irrelevant to the addressing). In other words, tag identifiers are specific to the context of the data rather than to the apportionment of addresses in memory. The term “DRAM address” is used herein to refer to either a physical address of the memory array 120 or to a logical address, but not to a tag identifier.

The memory device 104 and host 102 can be a personal laptop computer, a desktop computer, a digital camera, a mobile telephone, a memory card reader, or an Internet-of-Things (IoT) enabled device, an automobile, among various other types of systems. For clarity, the system has been simplified to focus on features with particular relevance to the present disclosure. The host 102 can include a number of processing resources (e.g., one or more processors, microprocessors, or some other type of controlling circuitry) capable of accessing the memory device 104.

The memory device 104 can provide main memory for the host 102 or can be used as additional memory or storage for the host 102. By way of example, the memory device 104 can be a dual in-line memory module (DIMM) including memory devices 104 operated as double data rate (DDR) DRAM, such as DDR5, a graphics DDR DRAM, such as GDDR6, or another type of memory system. Another example of a memory device, such as a Low-Power Double Data Rate (LPDDR) memory, also know as LPDDR SDRAM, is a type of synchronous dynamic random-access memory that consumes less power and is targeted for mobile computers and devices, such as mobile phones. Embodiments are not limited to a particular type of memory device 104. Other examples of memory devices 104 include RAM, ROM, SDRAM, LPDRAM, PCRAM, RRAM, LPDDR, High Bandwidth Memory (HBM), flash memory, and three-dimensional cross-point, among others. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The control circuitry 106 can decode signals provided by the host 102. The control circuitry 106 can also be referred to as a command input and control circuit and can represent the functionality of different discrete ASICs or portions of different ASICs depending on the implementation. The signals can be commands provided by the host 102. These signals can include chip enable signals, write enable signals, and address latch signals, among others, that are used to control operations performed on the memory array 120. Such operations can include data read operations, data write operations, data erase operations, data move operations, etc. The control circuitry 106 can comprise a state machine, a sequencer, and/or some other type of control circuitry, which may be implemented in the form of hardware, firmware, or software, or any combination of the three.

Data can be provided to and/or from the memory array 120 via data lines coupling the memory array 120 to input/output (I/O) circuitry 110 via read/write circuitry 116. The I/O circuitry 110 can be used for bi-directional data communication with the host 102 over an interface. The read/write circuitry 116 is used to write data to the memory array 120 or read data from the memory array 120. As an example, the read/write circuitry 116 can comprise various drivers, latch circuitry, etc. In some embodiments, the data path can bypass the control circuitry 106.

The memory device 104 includes address circuitry 108 to latch address signals provided over an interface. Address signals are received and decoded by a row decoder 112 and a column decoder 114 to access the memory array 120. Data can be read from memory array 120 by sensing voltage and/or current changes on the sense lines using sensing circuitry 118. The sensing circuitry 118 can be coupled to the memory array 120. The memory array 120 can represent multiple banks of memory, illustrated in more detail in FIG. 3. The sensing circuitry 118 can comprise, for example, sense amplifiers that can read and latch a page (e.g., row) of data from the memory array 120. Sensing (e.g., reading) a bit stored in a memory cell can involve sensing a relatively small voltage difference on a pair of sense lines, which may be referred to as digit lines or data lines.

The memory array 120 can comprise memory cells arranged in rows coupled by access lines (which may be referred to herein as word lines or select lines) and columns coupled by sense lines (which may be referred to herein as digit lines or data lines). Although the memory array 120 is shown as a single memory array, the memory array 120 can represent a plurality of memory array arranged in banks of the memory device 104. The memory array 120 can include a number of memory cells, such as volatile memory cells (e.g., DRAM memory cells, among other types of volatile memory cells) and/or non-volatile memory cells (e.g., RRAM memory cells, among other types of non-volatile memory cells).

The control circuitry 106 can also include a number of registers 122 (e.g., mode registers) and/or an on-die storage array (not specifically illustrated) that store default settings for the memory array 120 that can be changed by operation thereof. The registers 122 can be read and/or written based on commands from the host 102, a controller, and/or control circuitry 106.

The control circuitry 106 can also include a tag controller 124. In some embodiments, the tag controller 124 can be configured to maintain a tag match table that indicates correspondence between a respective tag identifier of a plurality of tag identifiers and a respective plurality of DRAM addresses for each of the plurality of tag identifiers. A “tag identifier” indicates an association between data stored in a first memory location and data stored in a second memory location. In some embodiments, a tag identifier can comprise a tag address and/or a tag name. The tag address can be an address for the tag identifier in the tag match table. The tag name can be a name associated with the tag identifier such that a request for the tag name is a request for the data associated with the tag identifier. In some embodiments, a request for either the tag name or the tag address can result in the retrieval of the data associated with the tag identifier.

If control circuitry 106 receives a request for data that is associated with data stored in a different DRAM address by a tag identifier, the control circuitry 106 can send that request to the tag controller 124 and the tag controller 124 can retrieve the requested data as well as the data that is associated with the requested data by the tag identifier. However, if the control circuitry 106 receives a request for data stored in a DRAM address that is not associated with data stored in another DRAM address by a tag identifier, the control circuitry 106 can access the data stored in the DRAM address without the use of the tag match table and retrieve the requested data.

FIG. 2 is a table for a tag match engine of a memory device according to the present disclosure. The table (e.g., tag match table) 226 can include a DRAM address list 228 and a tag value list 230. In some embodiments, the tag match table 226 can be included in a tag match engine of a DRAM memory device and/or a register (e.g., register 122 in FIG. 1).

In some embodiments, a tag match table 226 can indicate a correspondence between a respective tag identifier and a respective plurality of DRAM addresses for each of a plurality of tag identifiers. This correspondence can be indicated by associating DRAM addresses 229-1, 229-2, . . . , 229-N in a DRAM address list 228 with tag identifier values 231-1, 231-2, . . . , 231-N in a tag identifier value list 230. The DRAM address list 228 can be a list that includes the addresses of the locations at which data is stored that has been linked by a tag identifier. In some embodiments, the DRAM address list can include the DRAM addresses that are linked by a tag identifier instead of showing data that is linked by a tag identifier. The tag identifier value list 230 can be a list that includes the values of the tag identifiers that associate the data in a first memory location with the data stored in a second memory location. The tag identifier value can be a string of numbers and/or letters. When the tag controller (e.g., tag controller 124 in FIG. 1) receives a request for data that is associated with a tag identifier, the tag controller can search the tag match table 226 to determine whether the tag identifier corresponding to the request for data has a value. If the tag identifier has a value, the data associated with the tag identifier can be retrieved by the tag controller. If the tag identifier does not have a value, the data associated with the tag identifier may not be retrieved.

FIG. 3 illustrates a plurality of memory banks including data and a tag identifier according to the present disclosure. FIG. 3 illustrates a memory array 320, memory banks 332-1, 332-2, memory locations 333-1, 333-2, . . . , 333-N in a first memory bank 332-1 and memory locations 334-1, 334-2, . . . , 334-N in a second memory bank 332-2. In some embodiments, each memory location 333 and 334 can have a single DRAM address, a range of DRAM addresses, a linked list of DRAM addresses, or other instances of multiple DRAM addresses. Further, in some embodiments, at least one of memory locations 333 and 334 can have a single DRAM address and the others of memory locations 333 and 334 can have multiple DRAM addresses.

FIG. 3 conceptually illustrates a tag identifier 338 indicating more than one memory location. In particular, the tag identifier 338 indicates a first group of memory locations 336-1 (e.g., including memory location 333-1 and memory location 333-2) and a second group of memory locations 336-2 (e.g., including memory location 334-1 and memory location 334-2). In some embodiments, a respective plurality of DRAM addresses corresponding to the particular tag identifier 338 can include a first address 333 of a first memory bank 332-1 and a second address 334 of a second memory bank 332-2 of a memory array (e.g., DRAM memory array) 320. As shown in FIG. 3, a tag identifier 338 can associate a first group 336-1 of memory locations with a second group 336-2 of memory locations. In some embodiments, a first group 336-1 of memory locations can include every memory location 333 in a first memory bank 336-1 and a second group 336-2 can include every memory location 334 in a second memory bank 332-2. In other embodiments, a first group 336-1 of memory locations can include less than every memory location 333 in a first memory bank 336-1 and a second group 336-2 can include less than every memory location 334 in a second memory bank 332-2.

As shown in FIG. 3, a first group 336-1 of memory locations can include locations 333-1, 333-2 of a first memory bank 332-1 and a second group 336-2 of memory locations can include locations 334-1, 334-2 of a second memory bank 332-2. In some embodiments, the tag identifier 338 can associate address 333-1 of the group 336-1 with address 334-1 in group 336-2 and associate address 333-2 in group 336-1 and address 334-2 in group 336-2. In the embodiment shown in FIG. 3, data stored in memory locations 334-1 and 334-2 can be retrieved in response to a request for the tag identifier 338 resulting in a controller retrieving data stored in memory locations 333-1 and 333-2, respectively.

In some embodiments, the amount of data that a tag identifier associates can change based on whether data is added to or removed from the data set indicated by the tag identifier (e.g., user data such as a particular database, media file, etc.). For example, the quantity of memory locations 333, 334 and/or data stored in memory locations 333, 334 associated with the tag identifier 338 can increase if data is added to the data set. The quantity of memory locations 333, 334 and/or the amount of data stored in memory locations 333, 334 associated with the tag identifier 338 can decrease if data is removed from the data set identified by the tag identifier 338.

In some embodiments, different data sets can be merged (e.g., if the data associated with the different data sets becomes part of one data set). Merged data sets can become associated with a single tag identifier instead of different tag identifiers. Alternatively, a single data set can be split into multiple data sets. The multiple data sets can be associated with multiple tag identifiers (e.g., a new tag identifier can be assigned to the new data set that is split from the original data set).

In some embodiments, the DRAM addresses corresponding to a tag identifier can be kept in an ordered stack. A memory operation can be performed using the order of DRAM addresses in the ordered stack or a reversed order of the DRAM addresses. For example, a read operation can be performed on a DRAM address in the ordered stack and subsequent read operations be performed on subsequent DRAM addresses in the ordered stack until operations have been performed for each address in the ordered stack. This allows a request to perform the memory operation to include one address instead of multiple addresses since the memory operations will continue to be performed on subsequent addresses in the ordered stack.

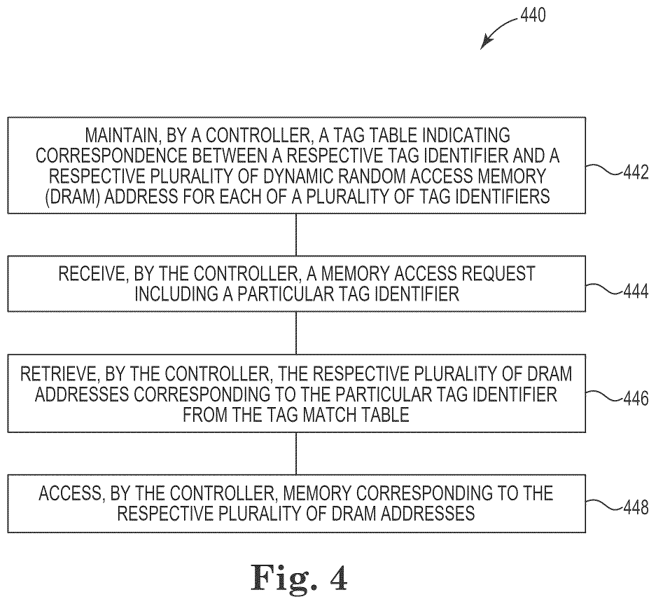

FIG. 4 illustrates a method for retrieving data that has been tagged with a tag identifier according to the present disclosure. The method 440 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 440 is performed by the tag controller 124 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At step 442 the method 440 can include maintaining, by a controller (e.g., tag controller 124 in FIG. 1), a tag table indicating correspondence between a respective tag identifier and a respective plurality of DRAM addresses for each of a plurality of tag identifiers. In some embodiments, a tag identifier can classify data stored in a first DRAM address and data stored in a second DRAM address as public or private. The tag identifier can assign an access level to the data stored in the first DRAM address and the data stored in the second DRAM address in response to the tag identifier classifying the data stored in the first DRAM address and the data stored in the second DRAM address as private. As used herein, the term “access level” refers to a security mechanism in which a memory device refrains from sending data stored in the memory device to a memory component that is requesting the data unless the request includes data indicating that the requesting memory component has permission to receive the requested data.

In some embodiments, the tag identifier can indicate whether data stored in a first DRAM address and data stored in a second DRAM address are in a first mode or a second mode. The first mode can allow for a greater level of interactivity with the data stored in the first DRAM address and the data stored in the second DRAM address than the second mode. As used herein, the term “level of interactivity” refers to the extent to which a user is able to interact with the application requesting the data. For example, if the data stored in the first DRAM address and the data stored in the second DRAM are part of a data set comprising an electronic document, the first mode can be editing-enabled mode and the second mode can be read-only mode. As used herein, editing-enabled mode allows a user to edit the electronic document and read-only mode allows a user to view the electronic document but does not allow the user to edit the electronic document. Editing-enabled mode allows for a greater level of interactivity than read-only mode due to user being able to edit the electronic document while it is in editing-enabled mode but unable to edit the electronic document while it is in read-only mode.

At step 444, the method 440 can include receiving, by a controller, a memory access request including a particular tag identifier. In some embodiments, the controller receiving the memory access request can be the memory controller (e.g., control circuitry 106 in FIG. 1). The memory controller can determine whether the request is a request for data that has been associated with other data by a tag identifier. In response to determining the request is a request for data that is associated with other data by a tag identifier, the memory controller can send the request to a tag controller (e.g., tag controller 124 in FIG. 1) and the tag controller can execute the request. In response to determining the request does not include a request for data that is associated with other data by a tag identifier, the memory controller can execute the request and retrieve the data. In some embodiments, the memory component that is requesting data stored in the memory device can send the request directly to the tag controller instead of sending the request to the memory controller.

At step 446, the method 440 can include retrieving, by the controller, the respective plurality of DRAM addresses corresponding to the particular tag identifier from the tag match table (e.g., tag match table 226 in FIG. 2). In some embodiments, a register (e.g., register 122 in FIG. 1) can store DRAM addresses corresponding to one or more tag identifiers. In some embodiments, the tag match table can be stored inside a register and in other embodiments, the tag match table can be stored outside of the register.

As stated previously, embodiments described herein can accommodate a refresh schedule in a more efficient manner than previous approaches. In some embodiments, if a memory component requests a data set with a corresponding tag identifier and if a first portion of that data set is associated with a first memory location that is experiencing a memory operation, a second portion of the data set that is associated with a second memory location that is not experiencing the memory operation can be accessed first. Then, the second portion of the data set can be accessed after the memory operation is performed at the first memory location. For example, if a first DRAM address stored in a first memory bank is associated with a second DRAM address in a second memory bank by a tag identifier, a controller can be configured to access the second memory bank prior to access the first memory bank in response to a refresh operation being executed on the first memory bank. In some embodiments, instead of a refresh operation, the memory operation can be a read operation or a write operation.

As stated above, the present disclosure can accommodate the refresh schedule of a memory device more efficiently than previous approaches. For example, if a memory device attempts to perform a write operation on a DRAM address that is experiencing a refresh operation, the memory device can choose a different DRAM address to temporarily store the data to be written during the write operation. After the refresh operation is complete, the data that is temporarily written to the alternative DRAM address can be copied to the original target address of the write operation. Further, the memory device continue to store the data written temporarily to the alternative DRAM address as a backup such that the data in the alternative DRAM address can be retrieved if a read command is to be performed on the original target DRAM address while the original target DRAM address is experiencing a refresh operation.

At step 448, the method 440 can include accessing, by the controller, memory corresponding to the respective plurality of DRAM addresses. After the controller accesses a DRAM address, the controller can retrieve the data stored at the DRAM address that has been accessed. As stated previously, a tag identifier can classify data stored in the DRAM addresses that are associated with each other by the tag identifier as either public or private. In some embodiments, a personal device can retrieve data stored in a first DRAM address and a second DRAM address in response to a memory device (e.g., DRAM memory device 104 in FIG. 1) receiving a request from the personal device for the tag identifier and determining, by the memory device, that the personal device has a respective access level that is greater than or equal to the access level of the data stored in the first DRAM address and the data stored in the second DRAM address. In some embodiments, the personal device may fail to retrieve the data stored in the first DRAM address and the second DRAM address in response to the DRAM memory device receiving a request from the personal device for the tag identifier and determining, by the memory device, that the personal device has a respective access level that is less than the access level of the data stored in the first DRAM address and the data stored in the second DRAM address.

Further, in some embodiments, the data stored in the first DRAM address has a first access level and the data stored in the second DRAM address has a second access level that is a different access level than the first access level. The personal device can retrieve the data stored in the first DRAM address and fail to retrieve the data stored in the second DRAM address in response to the DRAM memory device receiving a request from the personal device for the tag identifier and determining, by the DRAM memory device, that the personal device has a respective access level that is greater than or equal to the first access level but less than the second access level. In some embodiments, the controller can retrieve the data stored in the first DRAM address and the second DRAM address through I/O lines coupled to an external memory component (e.g., host 102 in FIG. 1) when the external memory component requests the data, and the controller can retrieve the data stored in the first DRAM address and the second DRAM address through I/O lines coupled to the personal device when the personal device requests the data. The I/O lines coupled to an external memory component and the I/O lines coupled to the personal device can be different I/O lines.

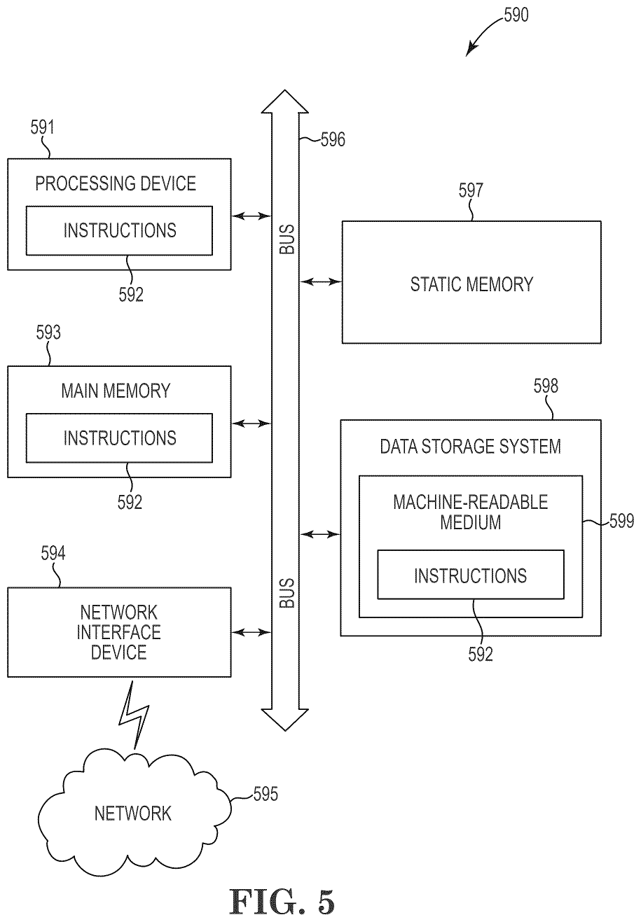

FIG. 5 illustrates an example machine of a computer system 590 within which a set of instructions, for causing the machine to perform any one or more of the methodologies discussed herein, can be executed. In some embodiments, the computer system 590 can correspond to a host system (e.g., the system 100 of FIG. 1) that includes, is coupled to, or utilizes a memory system (e.g., the memory device 104 of FIG. 1) or can be used to perform the operations of the tag controller (e.g., the tag controller 124 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

Processing device 591 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media.

In one embodiment, the instructions 592 include instructions to implement functionality corresponding to the control circuitry 106 of FIG. 1. While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus, comprising:
a dynamic random access memory (DRAM) array; and
a controller coupled to the DRAM array and configured to:
maintain a tag match table indicating correspondence between a respective tag identifier and a respective plurality of DRAM addresses for each of a plurality of tag identifiers;
receive a memory access request, including a particular tag identifier;
retrieve the respective plurality of DRAM addresses corresponding to the particular tag identifier from the tag match table; and
access memory corresponding to the respective plurality of DRAM addresses.

2. The apparatus of claim 1, wherein the respective plurality of DRAM addresses corresponding to the particular tag identifier includes a first address of a first memory bank of the DRAM array and a second address of a second memory bank of the DRAM array.

3. The apparatus of claim 2, wherein the controller is configured to access the second memory bank prior to the first memory bank in response to a refresh operation being executed on the first memory bank.

4. The apparatus of claim 1, wherein:
the respective plurality of DRAM addresses corresponding to the particular tag identifier comprises a first range of DRAM addresses and a second range of DRAM addresses; and
the first range of DRAM addresses is in a first memory bank of the DRAM array and the second range of DRAM addresses is in a second memory bank of the DRAM array.

5. The apparatus of claim 1, wherein the controller is further configured to:
receive a different memory access request including a particular DRAM address and not including a tag identifier; and
access memory corresponding to the particular DRAM address without use of the tag match table.

6. The apparatus of claim 1, wherein the tag identifier comprises a tag address.

7. The apparatus of claim 1, wherein the tag identifier comprises a tag name.

8. A method, comprising:
maintaining, by a controller, a tag match table indicating correspondence between a respective tag identifier and a respective plurality of dynamic random access memory (DRAM) addresses for each of a plurality of tag identifiers;
receiving, by the controller, a memory access request including a particular tag identifier;
retrieving, by the controller, the respective plurality of DRAM addresses corresponding to the particular tag identifier from the tag match table; and
access, by the controller, memory corresponding to the respective plurality of DRAM addresses.

9. The method of claim 8, further comprising classifying, using the tag identifier, data stored in a first DRAM address and data stored in a second DRAM address as public or private.

10. The method of claim 9, further comprising assigning, using the tag identifier, an access level to the data stored in the first DRAM address and the data stored in the second DRAM address in response to the tag identifier classifying the data stored in the first DRAM address and the data stored in the second DRAM address as private.

11. The method of claim 10, wherein a personal device retrieves the data stored in the first DRAM address and the second DRAM address in response to:
a DRAM memory device receiving a request from the personal device for the tag identifier; and
determining, by the DRAM memory device, that the personal device has a respective access level that is greater than or equal to the access level of the data stored in the first DRAM address and the data stored in the second DRAM address.

12. The method of claim 10, wherein a personal device fails to retrieve the data stored in the first DRAM address and the second DRAM address in response to:
a DRAM memory device receiving a request from the personal device for the tag identifier; and
determining, by the DRAM memory device, that the personal device has a respective access level that is less than the access level of the data stored in the first DRAM address and the data stored in the second DRAM address.

13. The method of claim 10, wherein the data stored in the first DRAM address has a first access level and the data stored in the second DRAM address has a second access level that is a different access level than the first access level.

14. The method of claim 13, wherein a personal device retrieves the data stored in the first DRAM address and fails to retrieve the data stored in the second DRAM address in response to:
a DRAM memory device receiving a request from the personal device for the tag identifier; and
determining, by the DRAM memory device, that the personal device has a respective access level that is greater than or equal to the first access level and the personal device has the respective access level that is less than the second access level.

15. The method of claim 14, further comprising retrieving, by the controller, the data stored in the first DRAM address and the data stored in the second DRAM address through first input/output (I/O) lines and retrieving, by the personal device, the data stored in the first DRAM address and the data stored in the second DRAM address through second I/O lines that are different than the first I/O lines.

16. The method of claim 8, further comprising identifying, by the tag identifier, data stored in a first DRAM address and the data stored in a second DRAM address in response to the controller associating the data stored in the first DRAM address with the data stored in the second DRAM address.

17. The method of claim 16, further comprising identifying, by the tag identifier, data stored in a third DRAM address and data stored in a fourth DRAM address in response to the controller associating the data stored in the third DRAM address to the data stored in the fourth DRAM address.

18. The method of claim 17, wherein the first DRAM address and the third DRAM address are stored in a first memory bank, and the second DRAM address and the fourth DRAM address are stored in a second memory bank.

19. A system, comprising:
a host; and
a memory device coupled to the host, wherein the memory device includes:
a dynamic random access memory (DRAM) array;
a memory device controller coupled to the DRAM array and configured to receive, from the host, a request for data stored in the DRAM array, wherein the memory device controller includes:
a tag register configured to store a tag identifier name; and
a tag controller configured to:
maintain a tag match table indicating correspondence between a respective tag identifier and a respective plurality of DRAM addresses for each of a plurality of tag identifiers;
receive, from the memory controller, a memory access request, including a particular tag identifier;
retrieve the respective plurality of DRAM addresses corresponding to the particular tag identifier from the tag match table; and
access memory corresponding to the respective plurality of DRAM addresses.

20. The system of claim 19, wherein:
the tag identifier indicates whether data stored in a first DRAM address and data stored in a second DRAM address are in a first mode or a second mode; and
the first mode allows for a greater level of interactivity with the data stored in the first DRAM address and the data stored in the second DRAM address than the second mode.
